(19) United States
(12) Patent Application Publication
(10) Pub. No.: US 2014/0211062 A1
(43) Pub. Date: Jul. 31, 2014

(54) ELECTRONIC DEVICE AND CAMERA SWITCHING METHOD THEREOF

(71) Applicant: HTC CORPORATION, TAOYUAN CITY (TW)

(72) Inventors: Ting-Chia Kuo, TAOYUAN CITY (TW); Jorge Taketoshi Furuya Mariche, TAOYUAN CITY (TW); Sung-Hao Lin, TAOYUAN CITY (TW)

(73) Assignee: HTC CORPORATION, TAOYUAN CITY (TW)

(21) Appl. No.: 14/162,893

(22) Filed: Jan. 24, 2014

Related U.S. Application Data
(60) Provisional application No. 61/756,486, filed on Jan. 25, 2013.

(51) Int. Cl. H04N 5/232

(52) U.S. Cl. CPC H04N 5/23293
USPC 348/333.01

(57) ABSTRACT

An electronic device and a camera switching method thereon are provided. The electronic device includes a first camera module, a second camera module, a touch screen and a processor. The touch screen is configured to detect a touch event, wherein the touch event is triggered as the touch screen is touched and dragged from a first position to a second position. The processor is configured to switch between the first camera module and the second camera module in response to the touch event. The camera switching method is applied to the electronic device to implement the operations.

This application claims priority to U.S. Provisional Patent Application No. 61/756,486 filed on Jan. 25, 2013.

### CROSS-REFERENCES TO RELATED APPLICATIONS

Not applicable.

### BACKGROUND OF THE INVENTION

1. Field of the Invention

The present invention relates to an electronic device and a camera switching method thereof More specifically, the present invention relates to an electronic device which is capable of switching camera modules in response to a touch event, and a camera switching method thereof.

2. Descriptions of the Related Art

Various electronic devices (e.g., smart mobile phones, notebook computers, tablet computers, digital cameras, etc.) have become indispensable to everyday lives of modern people. Almost all electronic device manufacturers have tried to design electronic devices to keep up with consumer needs. Among these designs, equipping a touch screen with an electronic device has been regarded as a basic requirement, and disposing two camera modules on one electronic device has also been regarded as one of the mainstreams in this art over recent years.

In such electronic device, the two camera modules may be disposed on different positions to sense different images from different perspectives and switched according to some steps to provide one of images provided by the camera modules for preview or shoot. The two camera modules may be switched according a series of steps which are instructed by tapping different positions of the touch screen many times. Also, the two camera modules may be switched according a series of steps which are instructed by tapping a keypad, moving a mouse or using other peripherals.

However, it is really cumbersome to switch between the two camera modules in such electronic device since the switching procedure of the two camera modules includes a series of steps. In view of this, an urgent need exists in the art to provide a solution to simplify the switching procedure of camera modules in such electronic device.

### SUMMARY OF THE INVENTION

The primary objective of the present invention is to provide a solution to the aforesaid problem in which the switching procedure of camera modules in conventional electronic device is really cumbersome. To achieve the objective, the present invention provides an electronic device which is capable of switching camera modules in response to a touch event, and a camera switching method thereof. In the present invention, two camera modules are switched from one to the other in response to a touch event detected by a touch screen.

Compared with the conventional switching procedure of camera modules, the touch event is just a simple operation such as a sliding motion on the touch screen. In such a way, the conventional switching procedure of camera modules would be simplified effectively.

In accordance with an aspect of the present invention, there is provided an electronic device comprising a first camera module, a second camera module, a touch screen and a processor coupled with the first camera module, the second camera module and the touch screen. The touch screen is configured to detect a touch event, wherein the touch event is triggered as the touch screen is touched and dragged from a first position to a second position. The processor is configured to switch between the first camera module and the second camera module in response to the touch event.

In one embodiment of the electronic device, the processor is further configured to initiate the second camera module in response to the touch event before the first camera module is switched to the second camera module. In this embodiment, the touch screen may further be configured to: display a first image frame which is provided by the first camera module until the second camera module is initiated; and display a second image frame which is provided by the second camera module after the second camera module is fully initiated. Optionally, the touch screen may further be configured to display a third image frame during the initiation of the second camera module.

In one embodiment of the electronic device, the first position is inside a first predetermined area next to one border of the touch screen and the second position is outside a second predetermined area next to the border of the touch screen. Preferably, the first predetermined area is ⅙ of the surface area of the touch screen and the second predetermined area is ⅓ of the surface area of the touch screen.

In accordance with another aspect of the present invention, there is provided a camera switching method for use in an electronic device comprising a first camera module, a second camera module, a touch screen and a processor. The camera switching method comprises the following steps of:
(a) detecting a touch event by the touch screen, wherein the touch event is triggered as the touch screen is touched and dragged from a first position to a second position; and
(b) switching between the first camera module and the second camera module by the processor in response to the touch event.

In one embodiment of the camera switching method, the step (b) further comprises the step of: (b1) initiating the second camera module by the processor in response to the touch event before the first camera module is switched to the second camera module. In this embodiment, the camera switching method may further comprise the following steps of: (c) displaying a first image frame which is provided by the first camera module by the touch screen until the second camera module is initiated; and (d) displaying a second image frame which is provided by the second camera module by the touch screen after the second camera module is fully initiated. Optionally, the camera switching method may further comprise the following step of: (e) displaying a third image frame during the initiation of the second camera module.

In one embodiment of the camera switching method, the first position is inside a first predetermined area next to one border of the touch screen and the second position is outside a second predetermined area next to the border of the touch screen. Preferably, the first predetermined area is ⅙ of the surface area of the touch screen and the second predetermined area is ⅓ of the surface area of the touch screen.

The detailed technology and preferred embodiments implemented for the present invention are described in the following paragraphs accompanying the appended drawings for people skilled in this art to well appreciate the features of the claimed invention.

### BRIEF DESCRIPTION OF THE DRAWINGS

FIG. 1 is a schematic view illustrating the architecture of an electronic device according to a first embodiment of the present invention.

FIG. 2 is a schematic view illustrating a shape in association with the electronic device according to the first embodiment of the present invention.

FIGS. 3A and 3B are schematic views illustrating different touch events detected by a touch screen of the electronic device according to the first embodiment of the present invention.

FIG. 4 is a flowchart diagram of a camera switching method according to a second embodiment of the present invention.

FIG. 5 is a flowchart diagram of an example of the camera switching method according to the second embodiment of the present invention.

### DESCRIPTION OF THE PREFERRED EMBODIMENT

The present invention can be explained with reference to the following embodiments. However, these embodiments are not intended to limit the present invention to any specific environments, applications or implementations described in these embodiments. Therefore, the description of these embodiments is only for the purpose of illustration rather than to limit the present invention. In the following embodiments and attached drawings, elements not directly related to the present invention are omitted from depiction; and dimensional relationships among individual elements in the attached drawings are illustrated only for ease of understanding but not to limit the actual scale.

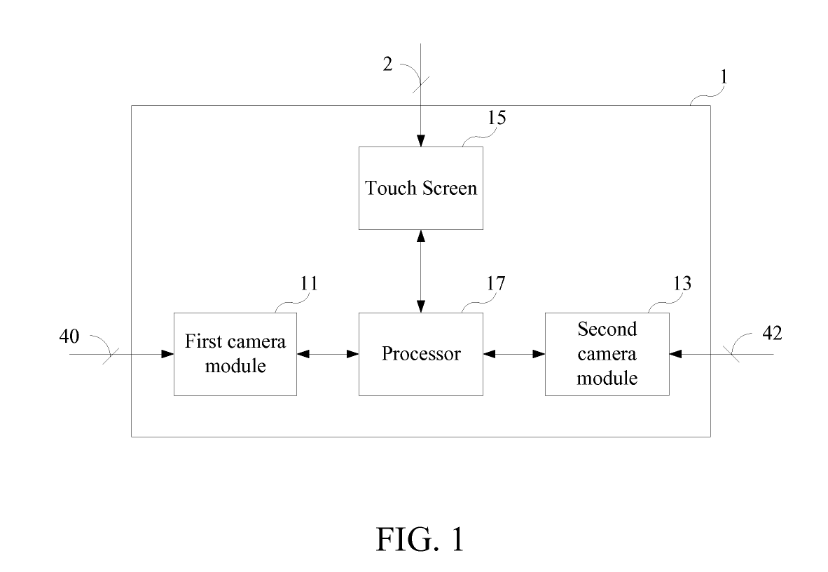

A first embodiment of the present invention is as shown in FIG. 1, which depicts the architecture of an electronic device 1. As shown in FIG. 1, the electronic device 1 comprises a first camera module 11, a second camera module 13, a touch screen 15 and a processor 17, and the processor 17 is substantially coupled with the first camera module 11, the second camera module 13 and the touch screen 15.

The touch screen 15 is configured to detect a touch event 2 and it may have different implementations. For example, the touch screen 15 may be a capacitive touch screen, a resistive touch screen, a resistive-capacitive composite touch screen, an electromagnetic-induction touch screen, etc. The processor 17 is configured to switch between the first camera module 11 and the second camera module 13 in response to the touch event 2. The electronic device 1 may comprise other components, modules or interfaces; however, those not directly related to the present invention are all omitted from depiction.

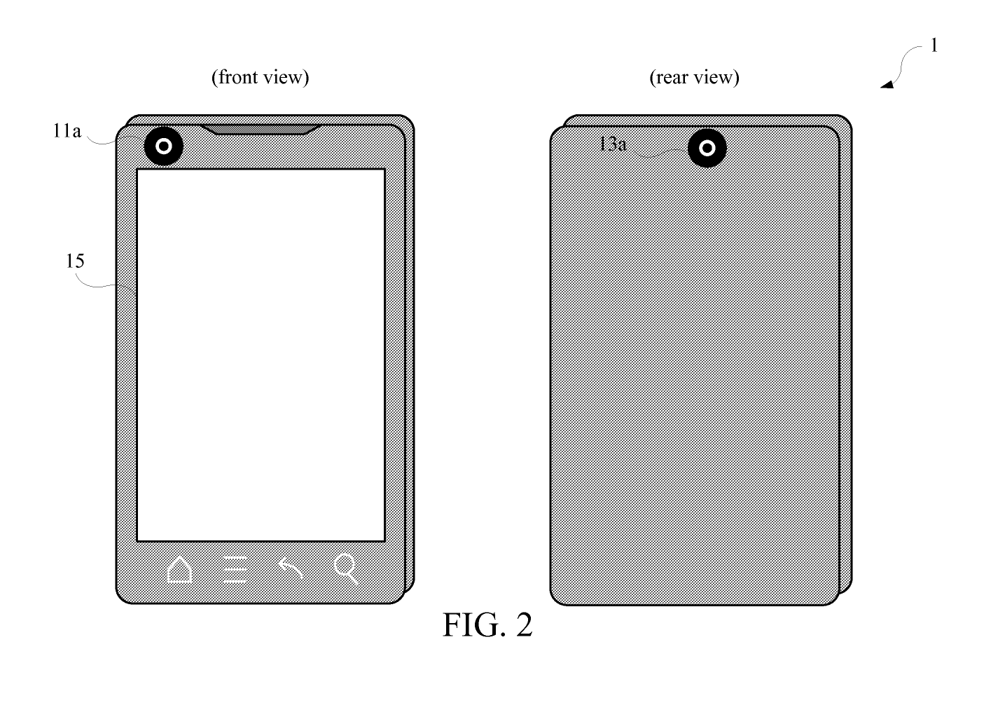

The electronic device 1 may be a smart phone as shown in FIG. 2, which depicts a shape of the electronic device 1. In another embodiment of the present invention, the electronic device 1 may be some other electronic devices such as a notebook computer, a tablet computer, a personal digital assistant (PDA), a digital camera, etc. As shown in FIG. 2, the first camera module 11 comprises a first camera lens 11a disposed on the front of the electronic device 1, and the second camera module 13 comprises a second camera lens 13a disposed on the rear of the electronic device 1.

Note that the layout of the first camera lens 11a and the second camera lens 13a is not intended to limit the implements of the present invention, but only for the ease of descriptions. For example, in another embodiment of the present invention, the first camera lens 11a and the second camera lens 13a may also be disposed on both sides of the electronic device 1 or disposed on the one plane of the electronic device 1 with a distance apart.

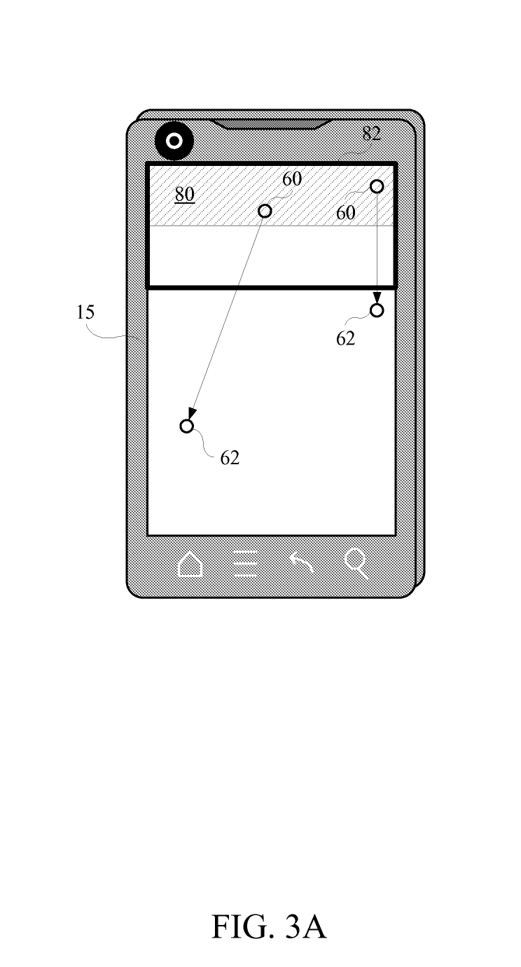

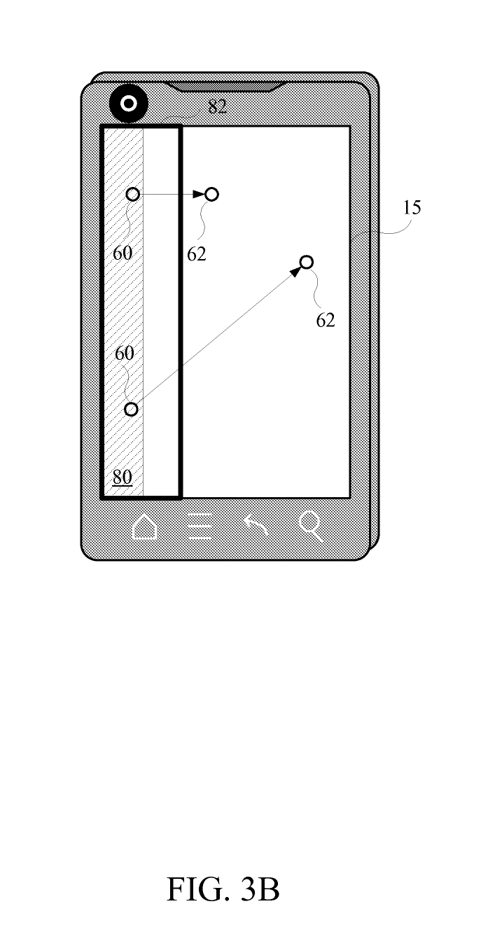

The method in which the touch screen 15 detects the touch event 2 will be further described hereinafter with reference to FIGS. 3A and 3B, which depict different touch event 2 detected by touch screen 15 of the electronic device 1. Compared with the conventional switching procedure, the touch event 2 is just a simple operation such as a sliding motion on the touch screen 15. In this embodiment, the touch event 2 is triggered as the touch screen 15 is touched and dragged from a first position 60 to a second position 62.

As shown in FIG. 3A, the first position 60 may be regarded as any position inside a first predetermined area 80 next to the upper border of the touch screen 15 and the second position may be regarded as any position outside a second predetermined area 82 next to the upper border of the touch screen 15. Likewise, as shown in FIG. 3B, the first position 60 may also be regarded as any position inside a first predetermined area 80 next to the left border of the touch screen 15 and the second position may be regarded as any position outside a second predetermined area 82 next to the left border of the touch screen 15. Preferably, the second position 62 may be regarded as any position outside but close to the second predetermined area 82 as far as possible.

The sizes of the first predetermined area 80 and the second predetermined area 82 may be predetermined and adjustable for different applications. For example, the first predetermined area 80 may be ⅙ of the surface area of the touch screen 15 and the second predetermined area 82 may be ⅓ of the surface area of the touch screen 15. Optionally, the first predetermined area 80 may also be ⅛ of the surface area of the touch screen 15 and the second predetermined area 82 may also be ¼ of the surface area of the touch screen 15.

Under the condition, when any position inside the first predetermined area 80 is touched and dragged to any position outside the second predetermined area 82, the touch event 2 is triggered and detected by the touch screen 15. Then, the processor 17 switches the first camera module 11 and the second camera module 13 from one to the other in response to the touch event 2. In practice, a user may touch a position inside the first predetermined area 80 or touch it with a slight movement, intentionally or unintentionally, etc. To reduce the influence incurred by such slight touch and/or movement, the processor 17 does not switch the first camera module 11 and the second camera module 13 from one to the other if a position inside the first predetermined area 80 is touched but not dragged to a position outside the second predetermined area 82 completely. In doing so, various incidentally false operations can be prevented effectively.

An example is further provided to describe the switch between the first camera module 11 and the second camera module 13. In this example, it is presumed that the first camera module 11 is running and the second camera module 13 is idle, and the touch screen 15 may still display a first image frame 40 which is provided by the first camera module 11 until the second camera module 13 is initiated.

Under the condition, when the touch event 2 is triggered and detected by the touch screen 15, the processor 17 initiates the second camera module 13 in response to the touch event 2. Once the second camera module 13 is fully initiated, the second camera module 13 becomes running and the first camera module 11 becomes idle. In the meantime, the touch screen 15 displays a second image frame 42 which is provided by the second camera module 13.

Depending on different types of the electronic device 1, the initiation time of the second camera module 13 may be longer. Therefore, the touch screen 15 may also display a third image frame (not shown) during the initiation of the second camera module 13. The third image frame is used to cover the display of the touch screen 15 during the initiation of the second camera module 13, and it may be a specific image including some indications, a predetermined background, or a predetermined photograph, etc.

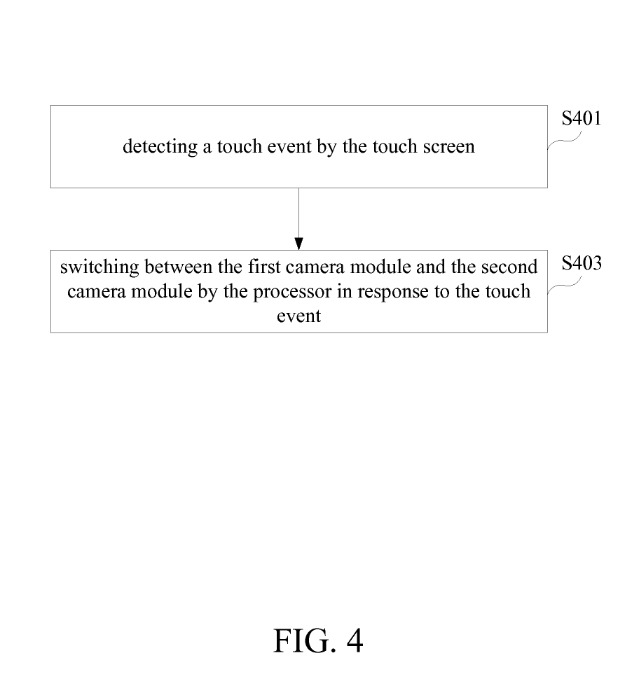

A second embodiment of the present invention is as shown in FIG. 4, which depicts a flowchart diagram of a camera switching method. The camera switching method of this embodiment can be applied in an electronic device comprising a first camera module, a second camera module, a touch screen and a processor, e.g., the electronic device 1 of the first embodiment.

As shown in FIG. 4, step S401 is executed to enable the touch screen to detect a touch event, wherein the touch event is triggered as the touch screen is touched and dragged from a first position to a second position; and step S403 is executed to enable the processor to switch between the first camera module and the second camera module in response to the touch event. As described in the first embodiment of the present invention, the first position may be inside a first predetermined area next to one border of the touch screen and the second position may be outside a second predetermined area next to the border of the touch screen. The first predetermined area may be ⅙ of the surface area of the touch screen and the second predetermined area may be ⅓ of the surface area of the touch screen.

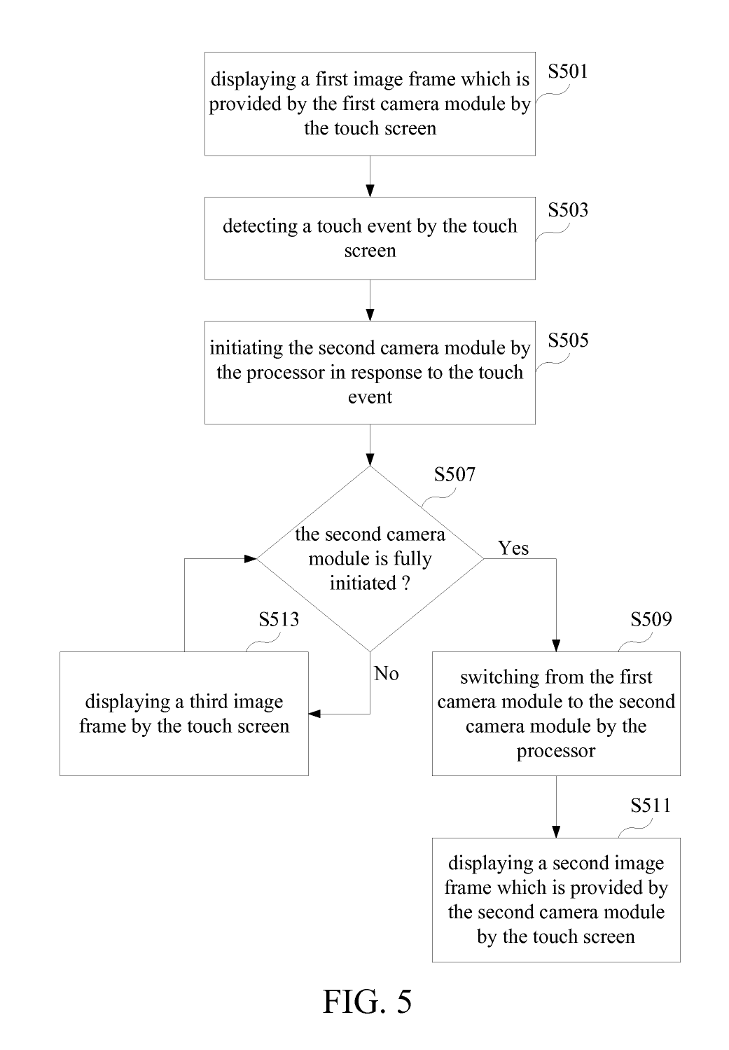

An example with reference to FIG. 5 is further provided to describe the camera switching method of this embodiment. As shown in FIG. 5, step S501 is executed to enable the touch screen to display a first image frame which is provided by the first camera module. Step S503 is executed to enable the touch screen to detect a touch event, wherein the touch event is triggered as the touch screen is touched and dragged from a first position to a second position. When the touch event is detected by the touch screen, step S505 is executed to enable the processor to initiate the second camera module in response to the touch event.

Next, step S507 is executed to enable the processor to determine whether the second camera module is fully initiated or not. If the second camera module is fully initiated, step S509 is executed to enable the processor to switch from the first camera module to the second camera module. Meanwhile, step S511 is executed to enable the touch screen to display a second image frame which is provided by the second camera module. Otherwise, step S513 is executed to enable the touch screen to display a third image frame until the second camera module is fully initiated.

In addition to the aforesaid steps, the camera switching method of this embodiment can also execute all the operations of the electronic device 1 set forth in the first embodiment and accomplish all the corresponding functions. The method in which the camera switching method of this embodiment executes these operations and accomplishes these corresponding functions can be readily appreciated by those of ordinary skill in the art based on the explanations of the first embodiment, and thus will not be further described herein.

According to the above descriptions, the present invention provides an electronic device which is capable of switching camera modules in response to a touch event, and a camera switching method thereof In the present invention, two camera modules are switched from one to the other in response to a touch event detected by a touch screen. Compared with the conventional switching procedure of camera modules, the touch event is just a simple operation such as a sliding motion on the touch screen. In such a way, the conventional switching procedure of camera modules would be simplified effectively. Consequently, the present invention provides a good solution to the aforesaid problem in which the switching procedure of camera modules in conventional electronic device is really cumbersome.

The above disclosure is related to the detailed technical contents and inventive features thereof. Persons skilled in this art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An electronic device, comprising:
a first camera module;
a second camera module;
a touch screen, configured to detect a touch event; and
a processor, coupled with the first camera module, the second camera module and the touch screen and configured to switch between the first camera module and the second camera module in response to the touch event;
wherein the touch event is triggered as the touch screen is touched and dragged from a first position to a second position.

2. The electronic device as claimed in claim 1, wherein the processor is further configured to initiate the second camera module in response to the touch event before the second camera module is switched to the first camera module.

3. The electronic device as claimed in claim 2, wherein the touch screen is further configured to:
display a first image frame which is provided by the first camera module until the second camera module is initiated; and
display a second image frame which is provided by the second camera module after the second camera module is fully initiated.

4. The electronic device as claimed in claim 3, wherein the touch screen is further configured to display a third image frame during the initiation of the second camera module.

5. The electronic device as claimed in claim 1, wherein the first position is inside a first predetermined area next to one border of the touch screen and the second position is outside a second predetermined area next to the border of the touch screen.

6. The electronic device as claimed in claim 5, the first predetermined area is ⅙ of the surface area of the touch screen and the second predetermined area is ⅓ of the surface area of the touch screen.

7. A camera switching method for use in an electronic device, the electronic device comprising a first camera module, a second camera module, a touch screen and a processor, the camera switching method comprising the following steps of:
(a) detecting a touch event by the touch screen, wherein the touch event is triggered as the touch screen is touched and dragged from a first position to a second position; and
(b) switching between the first camera module and the second camera module by the processor in response to the touch event.

8. The camera switching method as claimed in claim 7, wherein the step (b) further comprises the following step of:
(b1) initiating the second camera module by the processor in response to the touch event before the first camera module is switched to the second camera module.

9. The camera switching method as claimed in claim 8, further comprising the following steps of:
(c) displaying a first image frame which is provided by the first camera module by the touch screen until the second camera module is initiated; and
(d) displaying a second image frame which is provided by the second camera module by the touch screen after the second camera module is fully initiated.

10. The camera switching method as claimed in claim 9, further comprising the following step of:
(e) displaying a third image frame by the touch screen during the initiation of the second camera module.

11. The camera switching method as claimed in claim 7, wherein the first position is inside a first predetermined area next to one border of the touch screen and the second position is outside a second predetermined area next to the border of the touch screen.

12. The camera switching method as claimed in claim 11, the first predetermined area is ⅙ of the surface area of the touch screen and the second predetermined area is ⅓ of the surface area of the touch screen.
